(19) United States
(12) Patent Application Publication
(10) Pub. No.: US 2010/0320725 A1
(43) Pub. Date: Dec. 23, 2010

(54) Motorcycle Golf Bag Trailer

(76) Inventor: Jim Thomas Thorpe, SR., Upper Marlboro, MD (US)

Correspondence Address: WILEY REIN LLP, 1776 K. STREET N.W., WASHINGTON, DC, 20006, US

(21) Appl. No.: 12/603,259

(22) Filed: Oct. 21, 2009

Related U.S. Application Data
(60) Provisional application No. 61/269,290, filed on Jun. 22, 2009.

(51) Int. Cl. B62D 63/06

(52) U.S. Cl. 280/400

(57) ABSTRACT

A trailer to transport golf equipment and other cargo in an enclosure towed behind a motorcycle or other properly-equipped vehicle includes a trailer frame and a cargo container mounted thereon and carried thereby. The trailer frame includes a tongue member extending therefrom and having a free end adapted to be releasably coupled to a trailer hitch and at least two wheels mounted to opposing sides of the trailer frame. The cargo container generally includes a container wall defining an enclosed cargo space and an access panel into the cargo space, and is about three times taller than it is wide so that it travels in a substantially vertical orientation. The interior of the cargo container is equipped to securely hold a golf bag containing golf clubs, and may also be adapted (e.g., with hooks, rods, and secondary storage compartments) to hold and other cargo.

### CROSS-REFERENCE TO RELATED APPLICATIONS

This application claims the benefit of U.S. provisional application No. 61/269,290, filed 22 Jun. 2009, which is hereby incorporated by reference as though fully set forth herein.

### BACKGROUND OF THE INVENTION

a. Field of the Invention

The instant invention relates to cargo containers for motor vehicles. In particular, the instant invention relates to a cargo container that enables golf clubs to be carried by a motorcyclist.

b. Background Art

In recent years, the popularity of golf has been increasing. This is due, in part, to the fact that golf can be enjoyed by young and old alike because, relative to many other sports often enjoyed by recreational athletes, golf requires a lower level of physical exertion.

Though many golf courses provide equipment (e.g., golf clubs and bags) for rental use, golfers often prefer to use their own equipment. Thus, golfers must be able to transport their equipment to and from the course. Golf equipment, however, may be bulky and cumbersome. Indeed, it is sometimes difficult for a golfer to fit his or her equipment in the trunk of a smaller automobile.

Many golfers are also avid motorcyclists. This segment of the golfing population often wishes to take advantage of fair weather in multiple ways—for example, by both playing golf and riding their motorcycles. U.S. Pat. No. 6,193,256 to Banary, Jr. discloses a golf equipment trailer capable of hitching to a motorcycle. The Banary, Jr. trailer, however, leaves golf equipment exposed to both the elements and road hazards. Moreover, the practicality of the Banary, Jr. trailer is substantially limited to a golf bag and the clubs therein, providing minimal provision for any other type of cargo.

### BRIEF SUMMARY OF THE INVENTION

It is therefore an object of the present invention to provide a motorcycle trailer that includes a cargo container suitable to carry golf equipment as well as other cargo.

Another object of the present invention is to provide a motorcycle trailer that includes a cargo container that protects golf equipment from environmental conditions and road hazards.

Yet another object of the present invention is to provide a motorcycle trailer that includes an aerodynamically-shaped cargo container suitable to carry golf equipment, thus preserving the performance and efficiency of the motorcycle to which the trailer is attached.

According to some embodiments of the present invention, a trailer includes: a trailer frame including a tongue member extending therefrom and having a free end adapted to be releasably coupled to a trailer hitch; at least two wheels mounted to opposing sides of the trailer frame; and a cargo container mounted on and carried by the trailer frame. The cargo container generally includes a container wall defining an enclosed cargo space and an access panel into the cargo space. The cargo container has a height and a width, with the height being about three times the width, and preferably has internal dimensions sufficient to accommodate a set of golf clubs in a golf bag.

Typically, the cargo container will be aerodynamically shaped in a direction substantially parallel to a direction in which the tongue member extends from the trailer frame. That is, the cargo container will be aerodynamically shaped in its direction of travel when being towed by a motorcycle or other properly-equipped vehicle. Thus, in some aspects of the invention, the cargo container is substantially cylindrical, while, in other aspects of the invention, the cargo container is teardrop shaped.

In general, the access panel will be located opposite the tongue member. This configuration facilitates easy access to the enclosed cargo space without having to negotiate cargo around the trailer frame and/or the wheels. It is also desirable for the access panel to include a lock in order to secure the access panel in a closed position.

In certain embodiments of the invention, the interior of the cargo container provides additional cargo holding and storing capabilities and features. For example, there may be one or more hooks, such as coat hooks, attached to the interior surface of the container wall. As another example, a rod, such as a closet rod, may be provided spanning the cargo space between hooks on opposite sides of the interior surface of the container wall. This rod may be movably coupled to one of the hooks and releasably coupled to the other so that it can be swung away and stowed when not in use.

For safety, it may be desirable to provide signal lights mounted to at least one of the cargo container and the trailer frame opposite the tongue member (e.g., rear facing, so as to be visible to other drivers). Of course, an electrical coupling may be provided to releasably and operably couple the signal lights to a vehicle signaling system such that the signal lights on the vehicle are relayed to the signal lights on the trailer.

For comfort, it may be desirable to mount the wheels to the trailer frame via a damping system. The elements of suitable damping systems include, for example, bump stops, springs, shock absorbers, and the like.

According to another embodiment of the invention, a trailer includes means for enclosing a golf bag containing a plurality of golf clubs in a substantially upright position; and means for attaching the enclosing means to a vehicle such that the enclosing means is towed behind the vehicle.

An advantage of the present invention is that it provides a safe, secure, and convenient way for motorcyclists to carry golf equipment.

Another advantage of the present invention is that it enables motorcyclists to protect golf equipment from environmental conditions and road hazards.

Still another advantage of the present invention is that it enables motorcyclists to carry golf equipment without adversely affecting the performance and efficiency of their motorcycles.

A further advantage of the present invention is that it provides motorcyclists with locker-like cargo storage that can be securely, safely, and conveniently towed by their motorcycles.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a rear view of a trailer according to some embodiments of the present invention.

FIG. 2 illustrates the cargo container shown in FIG. 1, with a portion of the container wall broken away to show the cargo space.

FIG. 3 is a side view of a trailer according to some embodiments of the present invention.

### DETAILED DESCRIPTION OF THE INVENTION

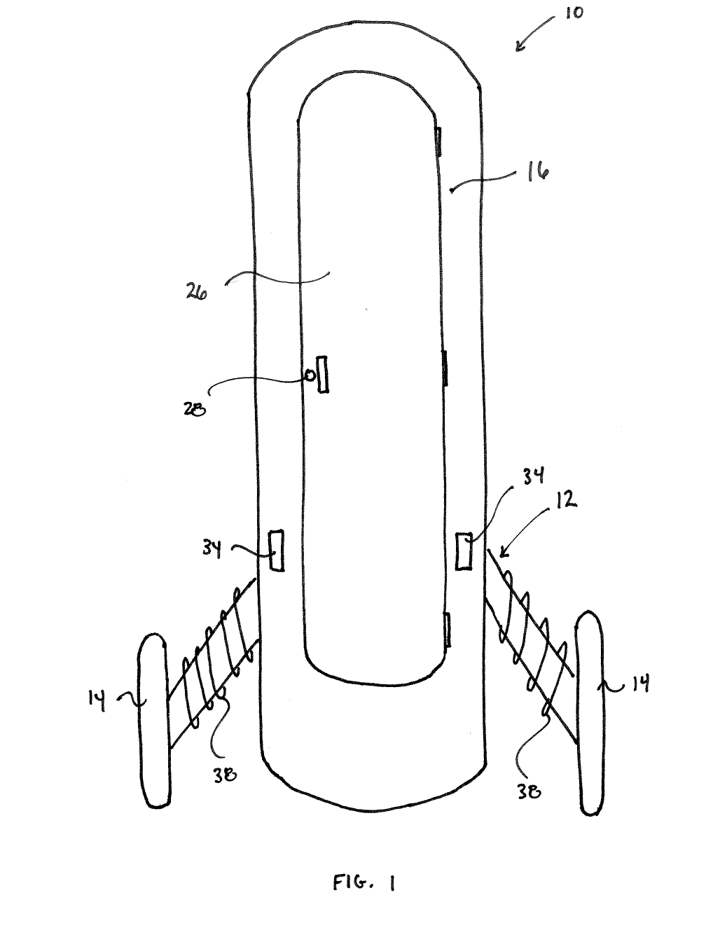

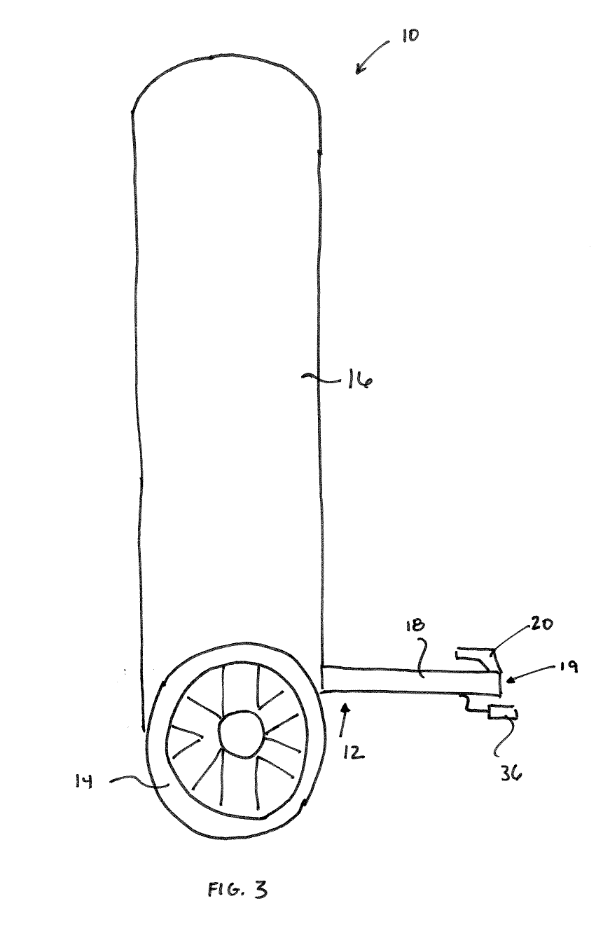

Referring now to the figures, there is depicted a trailer 10 according to some embodiments of the present invention. FIG. 1 depicts trailer 10 from the rear, while FIG. 3 depicts trailer 10 from the side.

Trailer 10 generally includes a trailer frame 12, at least two ground engaging wheels 14 mounted to opposing sides of trailer frame 12, and a cargo container 16 mounted on and carried by trailer frame 12. Trailer frame 12 includes a tongue member 18 that extends from the front of trailer frame 12. Tongue member 18 includes a free end (e.g., the end furthest away from cargo container 16) 19 that is adapted to be releasably coupled to a trailer hitch on a vehicle, such as a motorcycle. For example, a suitable coupling 20 may be provided at free end 19. Trailer 10 may also include a stand, such as a kickstand, enabling trailer 10 to remain upright when not coupled to a motorcycle. Trailer hitches and their corresponding couplings will be familiar to those of ordinary skill in the art, and thus will not be discussed in further detail herein.

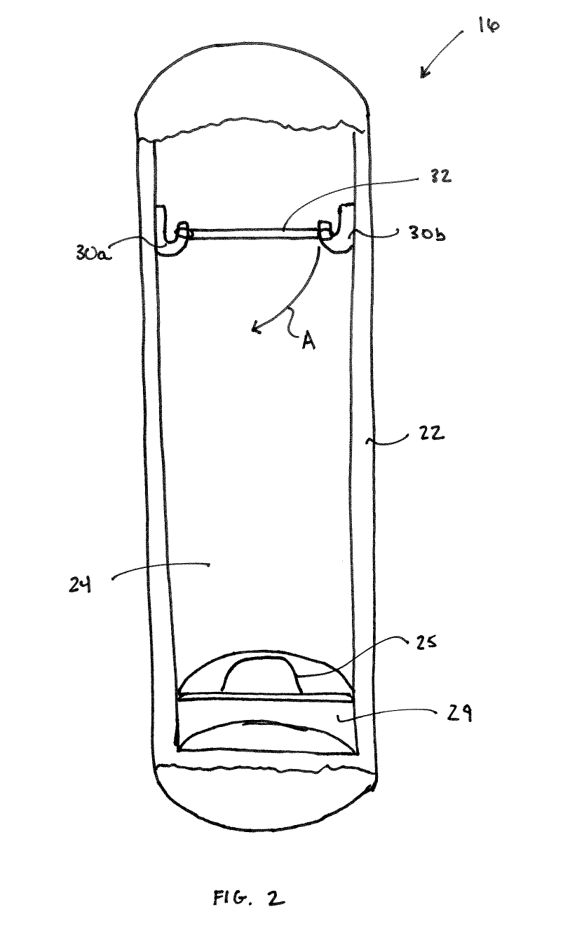

As seen in FIG. 2, cargo container 16 has a container wall 22 that defines an enclosed cargo space 24. Cargo container 16 is typically fashioned out of a material sufficiently durable to withstand environmental conditions and road hazards. Thus, suitable materials for cargo container 16 include, without limitation, fiberglass, plastic, metal, and combinations thereof.

To gain access to cargo space 24, a latching access panel, such as a door 26 (FIG. 1) is provided. Door 26 will typically be on the back side of cargo container 16 (that is, the side of cargo container 16 that is opposite tongue member 18). Door 26 may also include a lock 28 to secure door 26 in a closed position. Lock 28 may be any suitable lock, including, without limitation, key locks and combination locks.

Cargo space 24 is preferably dimensioned to accommodate golf equipment, such as a set of golf clubs in a golf bag, preferably in a substantially upright position. Thus, in certain embodiments of the invention, cargo container 16 is about three times taller than it is wide, giving it a substantially vertical orientation and a locker-like appearance. In some embodiments of the invention, cargo container 16 is about 54 inches tall, about 18 inches wide, and about 32 inches deep.

Cargo space 24 may also include suitable provisions to secure a golf bag, such as D-shaped bag seats/frames 25, bag straps, and the like. In addition, a compartment 29 may be provided in which to store golf shoes or other smaller items. Compartment 29 may be a sub-compartment within cargo space 24, either enclosed by door 26, or, alternatively, by a separate door or drawer pull (not shown) behind door 26. Of course, compartment 29 need not be separately enclosed, and may simply be partitioned off from the remainder of cargo space 24. In other embodiments of the invention, compartment 29 may entirely separate from cargo space 24 such that door 26 provides dedicated access to cargo space 24 while a second latching access panel (not shown) in cargo container 16 provides dedicated access to compartment 29.

It is also desirable for cargo container 16 to be aerodynamically shaped, particularly in a direction parallel to the direction in which tongue member 18 extends, as this is the direction in which cargo container 16 will typically travel. Thus, in some embodiments of the invention, cargo container 16 is substantially cylindrical. In other embodiments of the invention, cargo container 16 is teardrop-shaped. An aerodynamic configuration desirably minimizes drag, thereby preserving the efficiency and performance of the vehicle that is towing trailer 10. Moreover, because of its substantially upright orientation, cargo container 16 will generally be blocked by the motorcycle rider sitting upright on the bike in front of trailer 10, allowing cargo container 16 to “draft” behind the motorcycle.

It should be understood, of course, that cargo space 24 can conveniently accommodate other items as well. Thus, at least one, and preferably two, hooks 30a and 30b (FIG. 2) are optionally provided on the interior surface of container wall 22. In addition, a rod 32 may be provided to span the width of cargo space 24 in a manner similar to a closet rod. Preferably, one end of rod 32 is movably, yet substantially permanently, attached to one hook 30a (e.g., via a ball-and-socket or other joint), while the other end of rod 32 is adapted to be releasably coupled to the other hook 30b. Thus, when not in use, rod 32 can be disconnected from hook 30b and swung away in the direction of arrow A. A stowing mechanism, such as a strap, may be provided on container wall 22 near hook 30a to hold rod 32 in the stowed position. Of course, rod 32 may be releasably coupled to both hooks 30a, 30b, such that it can be entirely removed from cargo container 16 when not in use.

For safety, trailer 10 preferably includes rearward-facing signal lights 34, such as turn signal and brake lights. Signal lights 34 may be mounted to trailer frame 12 or cargo container 16 as desired. Signal lights 34 may also be operably coupled to an electrical coupling 36 (FIG. 3). Electrical coupling 36 is releasably and operably couplable to a vehicle's signaling system such that inputs to the vehicle (e.g., activation of a turn signal or braking) are output by signal lights 34. Trailer 10 may also include other reflective surfaces or markings to enhance visibility.

To enhance the ride of trailer 10, each wheel 14 may be mounted to trailer frame 12 via a damping system. This damping system may include at least one shock absorbing element, such as a spring 38 and shock absorber. One of skill in the art will appreciate, however, that the suspension of trailer 10 may have alternative configurations without departing from the spirit and scope of the present invention. It should also be understood that cargo container 16 may be weighted at its bottom in order to lower its center of mass.

In use, trailer 10 is coupled to a suitable trailer hitch on the rear of a motorcycle so that it is towed by the motorcycle. Golf equipment, such as clubs, a bag, an umbrella, shoes, and the like, can then be loaded into cargo container 16 through door 26. Cargo container 16 can then be locked such that these items can be transported in a secure fashion, protected from environmental conditions and road hazards. Upon arrival at the golf course, the rider/golfer can remove the golf equipment from cargo container 16 and use hooks 30a, 30b to hang his or her riding clothes (e.g., jacket and/or chaps). The rider/golfer's helmet and boots can also be placed within cargo container 16 and stored securely while the rider/golfer plays golf. This advantageously eliminates the need for the rider/golfer to procure storage, such as a locker, at the golf course, which may reduce the expense associate with playing golf.

Although several embodiments of this invention have been described above with a certain degree of particularity, those skilled in the art could make numerous alterations to the disclosed embodiments without departing from the spirit or scope of this invention. For example, though the present invention has been described in connection with transporting golf equipment, rod 32 can be used to hang a suit bag or garment bag, such that the rider can transport clothing, such as business or formal attire, without the clothing becoming creased. Likewise, though the invention has been described in connection with motorcycles, it can also be utilized with any vehicle fitted for towing (e.g., trikes).

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A trailer comprising:
a trailer frame including a tongue member extending therefrom, the tongue member having a free end adapted to be releasably coupled to a trailer hitch;
at least two wheels mounted to opposing sides of the trailer frame; and
a cargo container mounted on and carried by the trailer frame, the cargo container having a container wall defining an enclosed cargo space, the wall including an access panel into the cargo space,
wherein the cargo container has a height and a width, the height being about three times the width.

2. The trailer according to claim 1, wherein the cargo space is dimensioned to accommodate a set of golf clubs in a golf bag.

3. The trailer according to claim 1, wherein the cargo container is aerodynamically shaped in a direction substantially parallel to a direction in which the tongue member extends from the trailer frame.

4. The trailer according to claim 3, wherein the cargo container is substantially cylindrical.

5. The trailer according to claim 1, wherein the access panel is located opposite the tongue member.

6. The trailer according to claim 1, wherein the access panel includes a lock to secure the access panel in a closed position.

7. The trailer according to claim 1, further comprising at least one hook attached to an interior surface of the container wall.

8. The trailer according to claim 7, wherein the at least one hook comprises a pair of hooks attached to the interior surface of the container wall on opposing sides of the cargo space.

9. The trailer according to claim 8, further comprising a rod movably coupled to a first member of the pair of hooks and adapted to be releasably coupled to a second member of the pair of hooks in order to span the cargo space.

10. The trailer according to claim 1, further comprising signal lights mounted to at least one of the cargo container and the trailer frame opposite the tongue member.

11. The trailer according to claim 10, further comprising an electrical coupling operably coupled to the signal lights and adapted to be releasably and operably coupled to a vehicle signaling system.

12. The trailer according to claim 1, wherein each of the at least two wheels is mounted to the trailer frame via a damping system.

13. The trailer according to claim 12, wherein the damping system includes at least one shock-absorbing spring.

14. A trailer comprising:
means for enclosing a golf bag containing a plurality of golf clubs in a substantially upright position; and
means for attaching the enclosing means to a vehicle such that the enclosing means is towed behind the vehicle.
